(19) United States
(12) Patent Application Publication
(10) Pub. No.: US 2025/0196830 A1
(43) Pub. Date: Jun. 19, 2025

(54) ACCUMULATOR WITH SUPPLY VALVE AND BRAKE SYSTEM USING SAME

(71) Applicant: ZF Active Safety US Inc., Livonia, MI (US)

(72) Inventor: Blaise Ganzel, Ann Arbor, MI (US)

(21) Appl. No.: 18/544,535

(22) Filed: Dec. 19, 2023

(51) Int. Cl. B60T 13/14; B60T 8/1755; B60T 8/94; B60T 13/58; B60T 13/74

(52) U.S. Cl. CPC B60T 13/145; B60T 8/1755; B60T 8/94; B60T 13/58; B60T 13/745

(57) ABSTRACT

An accumulator assembly includes a medium pressure accumulator having an MPA cavity including at least one brake-side passage adjacent a first end thereof. A powered MPA two-way valve is interposed fluidically between the brake-side passage of the MPA cavity and at least one corresponding wheel brake. The MPA two-way valve includes an MPA two-way valve cavity placing the brake-side passage of the MPA cavity and the at least one corresponding wheel brake in selective fluid communication via both of an MPA two-way valve fill fluid path configured to provide pressurized hydraulic fluid to the MPA cavity and an MPA two-way valve supply fluid path configured to remove pressurized hydraulic fluid from the MPA cavity.

### RELATED APPLICATIONS

This application is related to the technologies disclosed in one or more of U.S. Provisional Patent Application No. 63/580,042 (attorney docket no. 301699-US-PSP), filed 1 Sep. 2023 and titled “Brake Systems with Motor-Driven Master Cylinders and Low Pressure Accumulators”; U.S. Provisional Patent Application No. 63/580,048 (attorney docket no. 301527-US-PSP), filed 1 Sep. 2023 and titled “Brake Systems with Motor-Driven Master Cylinders and Pump Inlet Attenuators”; U.S. patent application Ser. No. 18/474,714 (attorney docket no. 301527-US-NP), filed 26 Sep. 2023 and titled “Brake Systems with Motor-Driven Master Cylinders and Pump Inlet Attenuators”; U.S. patent application Ser. No. 18/474,657 (attorney docket no. 301146-US-NP), filed 26 Sep. 2023 and titled “Brake Systems with Motor-Driven Master Cylinders and Bypass Valves” (hereafter referenced as “the '657 application”); and U.S. patent application Ser. No. 18/474,678 (attorney docket no. 301699-US-NP), filed 26 Sep. 2023 and titled “Brake Systems with Motor-Driven Master Cylinders and Low Pressure Accumulators”; the entire contents of all of which are incorporated herein by reference for all purposes.

### TECHNICAL FIELD

This disclosure relates to an apparatus and method for use of an accumulator with a supply valve and a brake system using same, and, more particularly, to methods and apparatuses of brake systems with medium pressure accumulators having associated two-way solenoid-operated supply valves.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

It may be desirable to provide pressurized hydraulic fluid to a brake on an expedited basis, for some use environments (e.g., a “spike apply”, when the user “slams on” the brakes). Therefore, storage of pressurized hydraulic fluid in closer proximity to the brakes than the source(s) of the pressurized hydraulic fluid may be helpful in facilitating quick braking response, in some use environments. For example, some brake systems include a “running clearance” distance between the brake pads and rotors, to avoid unwanted drag and wear on the brakes when they are not in use. Particularly in a “spike apply” situation, a user may wish to quickly take up that running clearance distance, to avoid a delay (or the perception thereof by a driver) in brake actuation.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published 1 Oct. 2020 by Blaise Ganzel and titled “Brake System with Multiple Pressure Sources”, and in U.S. Patent Application Publication No. 2023/0048447, published 16 Feb. 2023 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, alone or in combination with any other aspect, an accumulator assembly is described. The accumulator assembly includes a medium pressure accumulator having an MPA cavity including at least one brake-side passage adjacent a first end thereof. An MPA piston is provided for reciprocal longitudinal motion within the MPA cavity responsive to a predetermined amount of hydraulic fluid flow through the brake-side passage. An MPA biasing spring urges the MPA piston toward the first end of the MPA cavity. A powered MPA two-way valve is interposed fluidically between the brake-side passage of the MPA cavity and at least one corresponding wheel brake. The MPA two-way valve includes an MPA two-way valve cavity placing the brake-side passage of the MPA cavity and the at least one corresponding wheel brake in selective fluid communication via both of an MPA two-way valve fill fluid path configured to provide pressurized hydraulic fluid to the MPA cavity and an MPA two-way valve supply fluid path configured to remove pressurized hydraulic fluid from the MPA cavity. An MPA two-way brake-fill valve seat is located along the MPA two-way valve supply fluid path and is at least partially defined by an interior wall of the MPA two-way valve cavity. An MPA two-way valve poppet is carried within the MPA two-way valve cavity. The MPA two-way valve poppet includes a poppet throughbore extending longitudinally therethrough from a first poppet end, adjacent the MPA two-way brake-fill valve seat, to a second poppet end separated longitudinally from the first poppet end. The second poppet end defines an MPA two-way MPA-fill valve seat located along the MPA two-way valve fill fluid path. The poppet throughbore selectively routes fluid flow therethrough along the MPA two-way valve fill fluid path. An MPA two-way valve MPA-fill occluder is located along the MPA two-way valve fill fluid path and is configured to selectively contact the MPA two-way MPA-fill valve seat. The MPA two-way valve poppet is configured for reciprocal motion between a poppet open position and a poppet closed position. Reciprocal motion of the MPA two-way valve poppet occurs at least partially responsive to a predetermined amount of fluid pressure differential between the MPA cavity and the at least one corresponding wheel brake. An MPA two-way valve poppet shoulder contacts the MPA two-way brake-fill valve seat to occlude fluid flow therepast along the MPA two-way valve supply fluid path responsive to the MPA two-way valve poppet achieving the poppet closed position. The MPA two-way valve MPA-fill occluder contacts the MPA two-way MPA-fill valve seat to occlude fluid flow therepast along the MPA two-way valve fill fluid path responsive to the MPA two-way valve poppet achieving the poppet open position.

### BRIEF DESCRIPTION OF THE DRAWINGS

For a better understanding, reference may be made to the accompanying drawings, in which:

FIG. 1 is a schematic cross-sectional view of a component of a brake system, according to an aspect of the present invention;

FIG. 2 is an enlarged view of area “2” of FIG. 1;

FIG. 3 is a schematic cross-sectional view of a portion of the component of FIG. 1, in a first condition;

FIG. 4 is a schematic cross-sectional view of the portion of FIG. 3, in a second condition;

FIG. 5 is a schematic cross-sectional view of the portion of FIG. 3, in a third condition; and

FIG. 6 is a schematic hydraulic diagram of an example brake system incorporating the component of FIG. 1.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

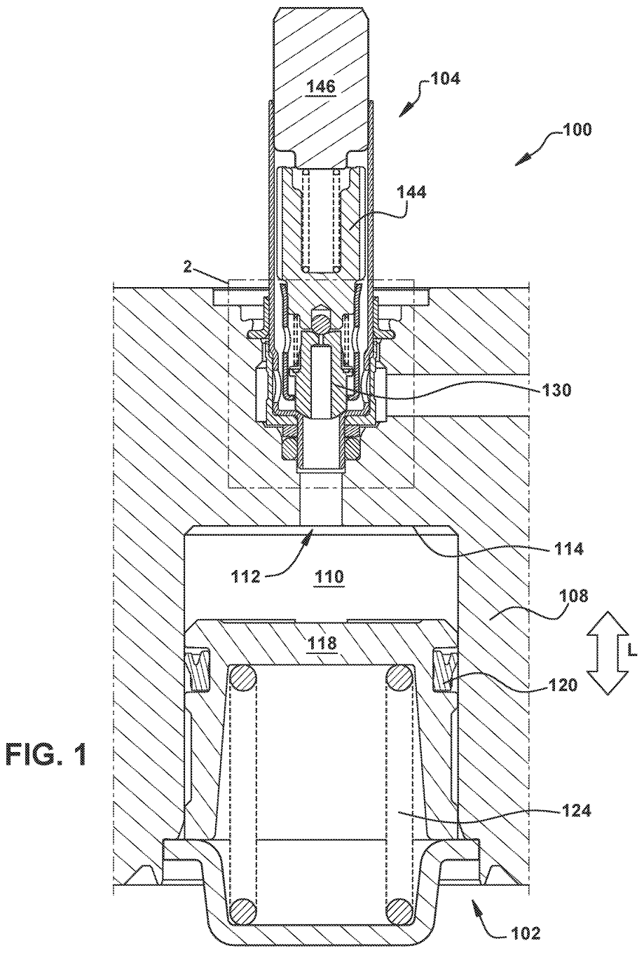

FIG. 1 schematically depicts an accumulator assembly 100, comprising a medium pressure accumulator 102 and a powered MPA two-way valve 104. The term “medium pressure” is used to indicate that the accumulator 102 is configured to hold, for example, an operating pressure of between about 3.9 and about 5.5 bar, in some use environments. This pressure capacity can be adjusted as desired by one of ordinary skill in the art by changing a size, shape, available spring force, configuration, and/or another property of at least one component of the medium pressure accumulator 102. The accumulator assembly 100 may be used, for example, in conjunction with a brake system, as will be discussed below in more detail. As a result of this “medium pressure” capability, the accumulator assembly 100 may have capacity for usefully storing (temporarily or permanently) and providing pressurized hydraulic fluid to other components of the brake system at a location that would not be practical for positioning of a lower-pressure accumulator (not shown). The accumulator assembly 100 can be housed in a block housing 10, shown schematically in the Figures, which may define components of the accumulator assembly 100; assist with assembling and maintaining components of the accumulator assembly 100 into an assembled device; and/or provide other housing, assembly, and/or maintenance functions as desired to any other components of the brake system.

The medium pressure accumulator 102 includes an MPA cavity 110 including at least one brake-side passage 112 at and/or adjacent a first end 114 of the MPA cavity 110. The MPA cavity 110 may be vented to atmosphere at a location spaced apart from the first end 114, as desired. An MPA piston 118 is configured for reciprocal longitudinal motion within the MPA cavity 110 responsive to a predetermined amount of hydraulic fluid flow through the brake-side passage 112. The “longitudinal” direction, as referenced herein pertaining to the MPA fill valve 104, is substantially parallel to arrow “L”, and is depicted as a vertical direction, in the orientation of FIG. 1. The MPA piston 118 can include at least one piston seal 120 or any other desired features, as can be configured by one of ordinary skill in the art. An MPA biasing spring 124 is provided for urging the MPA piston 118 toward the first end 114 of the MPA cavity 110.

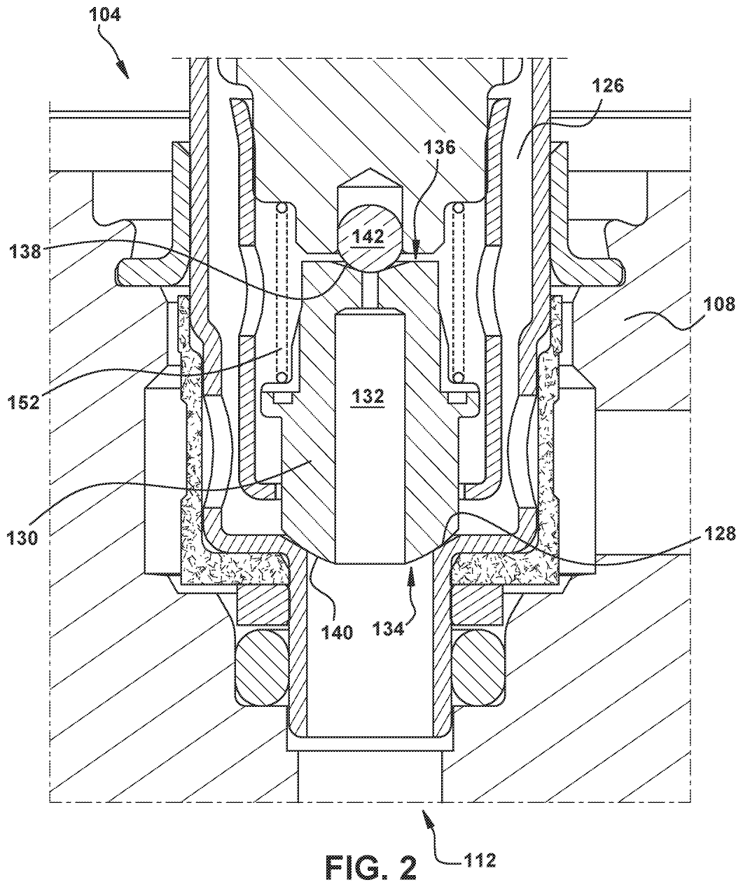

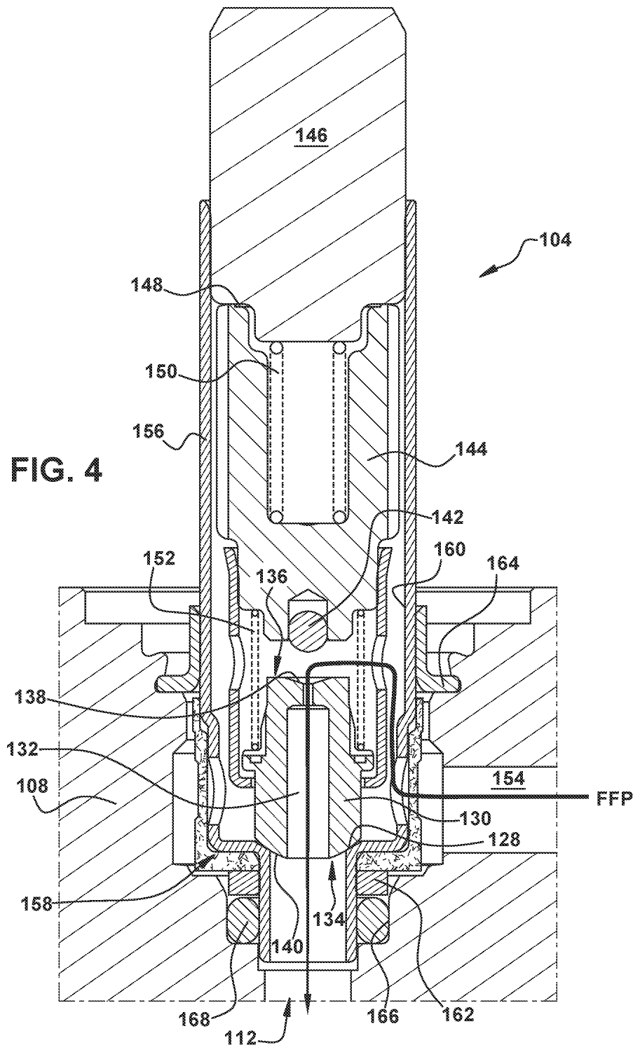

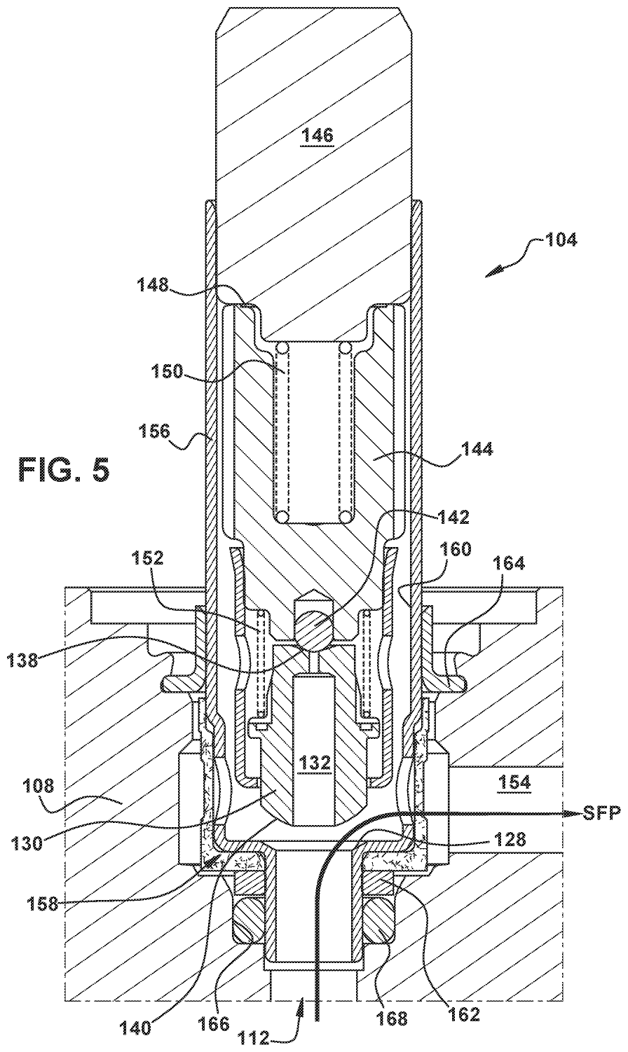

FIGS. 2-5 schematically depict the structures and operation of a powered MPA two-way valve 106 which is interposed fluidically between the brake-side passage 112 of the MPA cavity 110 and at least one corresponding wheel brake. The MPA two-way valve 106 includes an MPA two-way valve cavity 126 placing the brake-side passage 112 of the MPA cavity 110 and the at least one corresponding wheel brake in selective fluid communication via both of an MPA two-way valve fill fluid path configured to provide pressurized hydraulic fluid to the MPA cavity (shown schematically as FFP in FIG. 4) and an MPA two-way valve supply fluid path configured to remove pressurized hydraulic fluid from the MPA cavity (shown schematically as SFP in FIG. 5). An MPA two-way brake-fill valve seat 128 is located along the MPA two-way valve supply fluid path SFP and is at least partially defined by an interior wall of the MPA two-way valve cavity.

An MPA two-way valve poppet 130 is carried within the MPA two-way valve cavity 126. The MPA two-way valve poppet 130 includes a poppet throughbore 132 extending longitudinally therethrough from a first poppet end 134, adjacent the MPA two-way brake-fill valve seat 128, to a second poppet end 136 separated longitudinally from the first poppet end 134. The second poppet end 136 defines an MPA two-way MPA-fill valve seat 138 located along the MPA two-way valve fill fluid path FFP. The poppet throughbore 132 selectively routes fluid flow therethrough along the MPA two-way valve fill fluid path FFP. The MPA two-way valve poppet 130 is configured for reciprocal motion between a poppet open position (shown in FIG. 5) and a poppet closed position (shown in FIGS. 1-4). Reciprocal motion of the MPA two-way valve poppet 130 occurs at least partially responsive to a predetermined amount of fluid pressure differential between the MPA cavity 110 and the at least one corresponding wheel brake, as will be discussed in more detail below. An MPA two-way valve poppet shoulder 140 contacts the MPA two-way brake-fill valve seat 128 to occlude fluid flow therepast along the MPA two-way valve supply fluid path SFP responsive to the MPA two-way valve poppet 130 achieving the poppet closed position. This arrangement is shown in at least FIGS. 1-4.

An MPA two-way valve MPA-fill occluder 142, shown in the Figures as a ball or sphere held by another component, is located along the MPA two-way valve fill fluid path FFP and is configured to selectively contact the MPA two-way MPA-fill valve seat 138. The MPA two-way valve MPA-fill occluder 142 contacts the MPA two-way MPA-fill valve seat 138 to at least partially occlude fluid flow therepast along the MPA two-way valve fill fluid path FFP responsive to the MPA two-way valve poppet 130 achieving the poppet open position. A “fully open” version of this arrangement is shown in at least FIG. 5, though one of ordinary skill in the art will understand that certain fluid movement can occur (whether or not intentional) even when the components of the MPA two-way valve 106 are located in intermediate positions, traveling between those terminal configurations shown in the Figures and described herein.

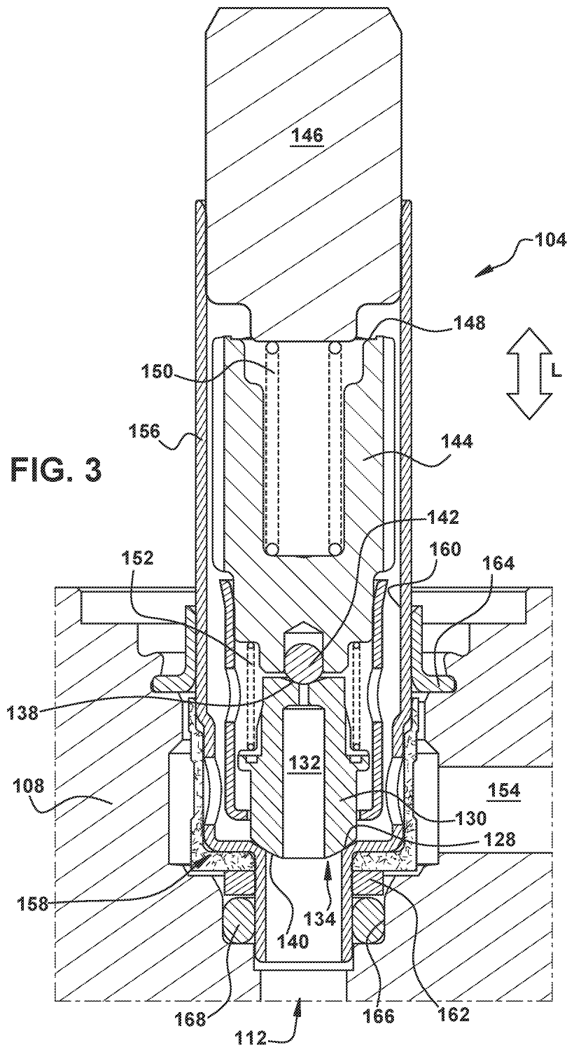

The MPA two-way valve 106 includes an armature 144 for selective longitudinally reciprocating motion with respect to the MPA two-way valve cavity 126 between first and second armature positions (shown in FIGS. 3 and 4-5, respectively). The “longitudinal” direction, as referenced herein with respect to the MPA two-way valve, is substantially parallel to arrow “L”, and is depicted as a vertical direction, in the orientation of FIGS. 3-5. The MPA two-way valve poppet 130 is held into engagement with the MPA two-way brake-fill valve seat 128, in the poppet closed position, responsive to the armature 144 being in the first armature position—again, this is the FIG. 3 configuration. In the FIGS. 4-5 configuration, respectively, the MPA two-way valve poppet 130 is permitted to selectively reciprocate between the poppet closed position and the poppet open position responsive to one or more of the armature 144 being in the second armature position, and a predetermined amount of fluid pressure differential between the MPA cavity 110 and the at least one corresponding wheel brake.

In the embodiment shown in the Figures, the MPA two-way valve MPA-fill occluder 142 comprises an occluder ball carried by the armature 144 (e.g., press-fit into a bore or aperture in the armature 144, as shown in the Figures) for selective engagement with the MPA two-way MPA-fill valve seat 138. However, it is contemplated that one of ordinary skill in the art can readily provide any desired number or type of valve seats and mating occluders, shoulders, stems, plugs, or other structures for achieving a desired fluid management response for a particular use environment.

The MPA two-way valve 106 includes a core 146 for selectively magnetically attracting the armature 144. The core 146 is located longitudinally directly adjacent a core-activated surface 148 of the armature 144. The armature 144 is longitudinally interposed between the core 146 and the MPA two-way valve poppet 130. The core 146 is selectively energized to magnetically drive the armature 144 between the first armature position of FIG. 3 and the second armature position of FIGS. 4-5. A core spring 150 biases the armature 144 toward the MPA two-way valve poppet 130—i.e., toward the first armature position—to make the MPA two-way valve 106 a normally-closed type of valve, which is then electrically (solenoid) actuated to selectively open.

The MPA two-way valve poppet 130 is held into engagement with the MPA two-way brake-fill valve seat 128, in the poppet closed position, responsive to the armature 144 being in the first armature position. As a result, the MPA two-way valve fill fluid path FFP and the MPA two-way valve supply fluid path SFP are both occluded when the armature 144 is in the first armature position, and pressurized hydraulic fluid is substantially prevented from travel between the medium pressure accumulator 102 and the wheel brake, in either direction, during normal operation of the MPA two-way valve 106. (It is contemplated, though, that in certain circumstances—e.g., high pressures developing in the MPA cavity 110 during a blockage—the pressure can cause a very small amount of fluid to travel past the MPA two-way brake-fill valve seat 128 as desired, and one of ordinary skill in the art can configure the valve appropriately.)

The MPA two-way valve poppet 130 is permitted to selectively reciprocate between the poppet closed position of FIGS. 3-4 and the poppet open position of FIG. 5 responsive to the armature 144 being in the second armature position. As a result, the MPA two-way valve fill fluid path FFP and the MPA two-way valve supply fluid path SFP may be occluded when the armature 144 is in the second armature position, or may not be occluded at that time, depending upon the position of the MPA two-way valve poppet 130. When the two-way valve poppet 130 is in the poppet closed position of FIG. 4, the MPA two-way valve fill fluid path FFP is open and the MPA two-way valve supply fluid path SFP is occluded. Conversely, when the two-way valve poppet 130 is in the poppet open position of FIG. 5, the MPA two-way valve fill fluid path FFP is at least partially occluded and the MPA two-way valve supply fluid path SFP is at least partially open. Thus, reciprocal motion of the MPA two-way valve poppet 130 between the poppet open position and the poppet closed position is operative to facilitate fluid flow between the MPA cavity 110 and at least one corresponding wheel brake alternately along the MPA two-way valve supply fluid path SFP and along the MPA two-way valve fill fluid path FFP, respectively.

A poppet spring 152 biases the MPA two-way valve poppet 130 toward the poppet closed position and thus biases the MPA two-way valve poppet shoulder 140 toward sealing engagement with the MPA two-way valve seat 138 when the armature 144 is in the second armature position. Again, this is the arrangement shown in FIG. 4. Conversely, reciprocal motion of the MPA two-way valve poppet 130 from the poppet closed position of FIG. 4 toward the poppet open position of FIG. 5 is permitted to occur at least partially responsive to a fluid pressure in the MPA cavity 110 (i.e., in the brake-side passage 112) being greater than a predetermined wheel-side fluid pressure (i.e., in the wheel-side passage represented by 154), which is related to fluid pressure at the at least one corresponding wheel brake, optionally adjusted to account for pressure drop occurring in an intervening length of hydraulic line travel. When the MPA two-way valve poppet 130 is urged toward the poppet closed position of FIG. 4 by at least one of the poppet spring 152 and fluid pressure from the wheel-side passage 154, the MPA two-way valve fill fluid path FFP is permitted to open, and pressurized hydraulic fluid flows through the MPA two-way valve 106, along the MPA two-way valve fill fluid path FFP, toward the medium pressure accumulator 102 in order to “charge” or refill the MPA cavity 110. In contrast, when the MPA two-way valve poppet 130 is urged toward the poppet open position of FIG. 5 by fluid pressure from the brake-side passage 112, the MPA two-way valve supply fluid path SFP is permitted to open, and pressurized hydraulic fluid flows through the MPA two-way valve 106, along the MPA two-way valve supply fluid path SFP, toward the brake to facilitate a “spike apply”, to take up running clearance, or otherwise to provide pressurized hydraulic fluid to the wheel brake in a desired manner for operation of the brake system. The FIG. 4 configuration of the MPA two-way valve 104, with the MPA two-way valve fill fluid path FFP open, can be helpful in “bleeding off” pressurized hydraulic fluid from the brake during a normal brake apply event, in order to prepare the medium pressure accumulator 102 with a full “charge” of pressurized hydraulic fluid, for later use in supplying such fluid to at least one corresponding wheel brake as desired. For example, the MPA fill valve fluid path FVP may include an MPA orifice (just below the MPA two-way MPA-fill valve seat 138) therealong, which serves to restrict fluid flow along the MPA fill valve fluid path FVP and into the medium pressure accumulator 102. The MPA orifice may be configured by one of ordinary skill in the art for a particular use application, and may be about 0.25 mm diameter for the accumulator assembly 100 configuration given via example quantifications herein. The MPA orifice 135, and the fluid flow restriction it provides, may be helpful in avoiding unwanted “dumping” or “cycling” of the fluid volume that comes out through the MPA two-way valve supply fluid path SFP to then just end up going back into the MPA cavity 110 through the MPA fill valve fluid path FVP.

Various orifice sizes, fluid paths, hydraulic passageways, and other components of the accumulator assembly 100 can be configured by one of ordinary skill in the art to achieve desired operational characteristics of the accumulator assembly 100 in a particular use environment.

The MPA two-way valve 106 may be configured and constructed in any desired manner, and may readily be provided by one of ordinary skill in the art for a desired use environment. By way of example, given the medium pressures previously mentioned, the MPA two-way valve fluid path SFP might be configured to take about 10 bars of force from the brake-side passage 112 direction (to overcome spring force of at least one of the core and poppet springs 150 and 152) to open when the MPA two-way valve 106 is in the FIG. 3 configuration, about 80 mbars (to overcome the force of the poppet spring 152 and shift the MPA two-way valve poppet 130 initially) to start opening in the FIG. 4 configuration, and about 180 mbars (to move the MPA two-way valve poppet 130 fully away from the MPA two-way valve seat 148) to fully open into the FIG. 5 configuration.

The example MPA two-way valve 106 configuration shown in the Figures includes a core sleeve 156 received at least partially in a housing 108 that also at least partially defining the MPA cavity 110. The core sleeve 156, when present, is configured to maintain the core 146 in spaced relationship with the armature 144. The armature 144 is at least partially enclosed within the core sleeve 156 is and guided thereby for selective longitudinal reciprocating motion with respect to the core 146, responsive to energization of the core 146. Optionally, and also as shown in the Figures, the core sleeve 156 may completely enclose the MPA two-way valve poppet 130.

The core sleeve 156 is shown as having a reduced-diameter sleeve shoulder 158, located on an opposite end of the MPA two-way valve poppet 130 from the core 146. The sleeve shoulder 158 at least partially defines the MPA two-way brake-fill valve seat 128 by comprising at least a portion of an interior wall 160 of the MPA two-way valve cavity 126, at that location on the MPA two-way valve 106.

Any desired number, configuration, and type of resilient seals 172, to prevent fluid leakage; retainers 174, to keep the components of the MPA two-way valve 106 spaced or arranged as desired; and/or flanges 176, to maintain the MPA two-way valve 106 within the block housing 108, may be provided by one of ordinary skill in the art for a particular use environment of the accumulator assembly 100. For example, the brake-side passage 112 of the MPA cavity 110 may include a circumferential groove 166 at least partially containing a resilient annular seal 168 surrounding at least an MPA-side portion of the MPA two-way valve 104, as shown in the Figures. When present, the annular seal 168 may help prevent unwanted passage (e.g., leakage) of hydraulic fluid between the MPA cavity 110 and the at least one corresponding wheel brake in either direction, apart from at least one of the MPA two-way valve supply fluid path SFP and the MPA two-way valve fill fluid path FFP.

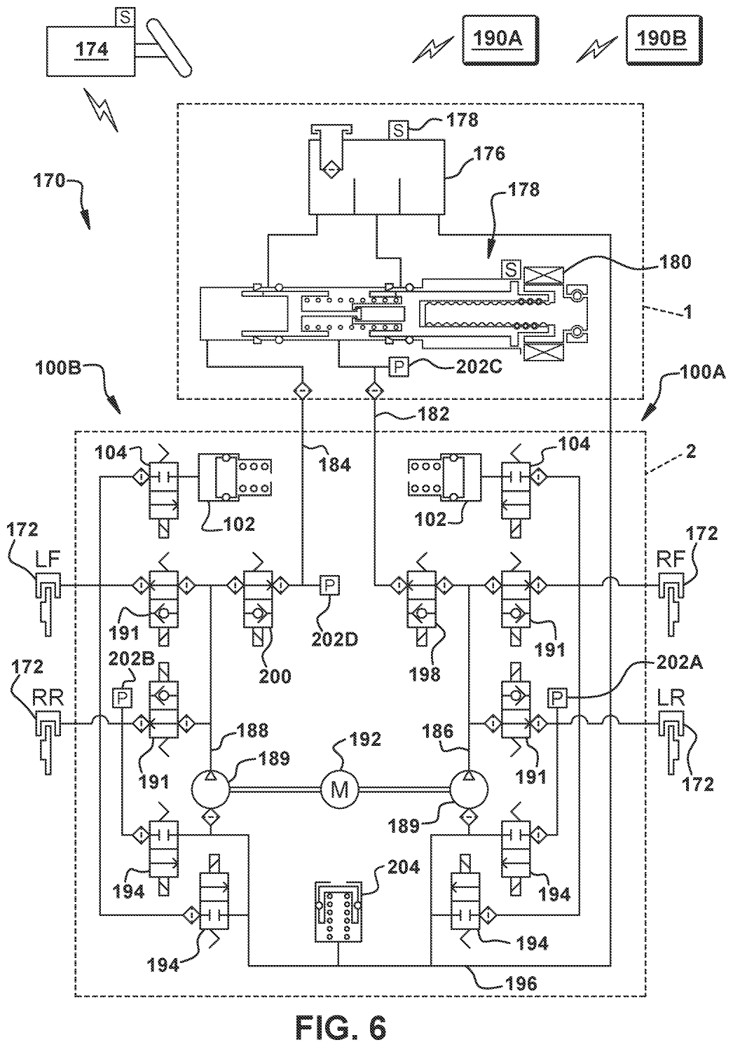

FIG. 6 schematically depicts an example brake system 170 for actuating a plurality of wheel brakes 172 comprising first and second pairs of wheel brakes 172. The brake system 170 is shown here as a hydraulic braking system, in which fluid pressure is utilized to apply braking forces for the brake system 170. The brake system 170 may suitably be used on a ground vehicle, such as an automotive vehicle having four wheels with a wheel brake associated with each wheel. Furthermore, the brake system 170 can be provided with other braking functions such as anti-lock braking (ABS) and other slip control features to effectively brake the vehicle. Components of the brake system 170 may be housed in one or more blocks or housings. The blocks or housings may be made from solid material, such as aluminum, that has been drilled, machined, or otherwise formed to house the various components. Fluid conduits may also be formed in the block or housing.

In the illustrated embodiment of the brake system 170 of FIG. 6, there are four wheel brakes 172, which each can have any suitable wheel brake structure operated electrically and/or by the application of pressurized brake fluid. Each of the wheel brakes 172 may include, for example, a brake caliper mounted on the vehicle to engage a frictional element (such as a brake disc) that rotates with a vehicle wheel to effect braking of the associated vehicle wheel. The wheel brakes 172 can be associated with any combination of front and rear wheels of the vehicle in which the corresponding brake system 170 is installed. For example, the brake system 170 may be configured as a vertically split or diagonally split system. No differentiation is made herein among the construction of the various wheel brakes 172, for the purposes of this description, though one of ordinary skill in the art could readily provide a suitable braking arrangement for a particular use environment. The wheel brakes 172 are described herein as comprising first and second pairs of wheel brakes 172, with the first and second pairs being characterized as RF/LR and LF/RR, as shown as FIG. 6, for the sake of description. However, LF/LR and RF/RR, or RF/LF and RR/LR, pairs could also or instead be specified for the brake system 170, as desired.

Also for the sake of description, it is presumed that a deceleration signal transmitter (shown schematically at 174) is configured to provide a braking signal, in a wired or wireless manner, corresponding to a desired braking action by an operator of the vehicle. The deceleration signal transmitter 174 could include, but not be limited to, a brake pedal, an autonomous braking controller, and/or any other suitable scheme for generating a braking signal from which the brake system 170 can be actuated.

The brake system 170 also includes a fluid reservoir 176. The reservoir 176 stores and holds hydraulic fluid for the brake system 170. The fluid within the reservoir 176 is preferably held at or about atmospheric pressure, but the fluid may be stored at other pressures if desired. The reservoir 176 is shown schematically as having three tanks or sections in FIG. 6, with fluid conduit lines connected thereto. The sections can be separated by several interior walls within the reservoir 176 and are provided to prevent complete drainage of the reservoir 176 in case one of the sections is depleted due to a leakage via one of the three lines connected to the reservoir 176. Alternatively, the reservoir 176 may include multiple separate housings. The reservoir 176 may include at least one fluid level sensor 177 for detecting the fluid level of one or more of the sections of the reservoir 176.

The motor-driven master cylinder (“MC” or “[primary] power transmission unit”) 178 (which may be a dual-chamber type master cylinder 178, also known as a tandem power transmission unit) of the brake system 170 functions as a source of pressure to provide a desired pressure level to the hydraulically operated wheel brakes 172 during a typical or normal non-failure brake apply. An example of a suitable MC 178 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes. The master cylinder 178 is operable during a normal non-failure braking mode by actuation of an electric motor 180 of the master cylinder 178 to generate brake actuating pressure at first and second MC outputs 182 and 184, respectively, for hydraulically actuating the first and second pairs of wheel brakes 172.

After a brake apply, fluid from the wheel brakes 172 may be returned to the master cylinder 178 and/or be diverted to the reservoir 176. It is also contemplated that other configurations (not shown) of the brake system 170 could include hydraulic control of just selected one(s) of the wheel brakes (with the others being electrically controlled/actuated). One of ordinary skill in the art would be readily able to provide such an arrangement for a desired use environment, following aspects of the present invention.

A secondary brake module is configured for selectively providing pressurized hydraulic fluid at first and second pump outputs 186 and 188, respectively, for actuating the first and second pairs of wheel brakes 172 in at least one of a normal non-failure braking mode and a backup braking mode. As shown in FIG. 6, the secondary brake module includes at least one pump piston 189 associated with at least one wheel brake 172 of the plurality of wheel brakes 172. The pump piston 189 is driven by an electric pump motor 192 (as differentiated from the electric motor 180 included in the master cylinder 178) which transmits rotary motion to each pump piston 189 for selectively providing pressurized hydraulic fluid to an iso/dump control valve arrangement of at least one wheel brake 172 which is associated with the pump piston 189. FIG. 6 shows one pump piston 189 as being associated with two wheel brakes 172, for a total of two pump pistons 189 in the brake system 170. Together, the pump piston(s) 190 and electric pump motor 192 can be considered to comprise a secondary brake module (A.K.A. “secondary power transmission unit”) of the brake system 170. For example, the two pump pistons 189 shown in the Figures may provide pressurized hydraulic fluid at first and second pump outputs 186 and 188, respectively, to the corresponding wheel brakes 172 via the corresponding iso/dump control valve arrangements (when present), to actuate the first and second pairs of wheel brakes 172 in at least one of a normal non-failure braking mode and a backup braking mode. Each of the first and second pump outputs 196 and 198 can provide fluid to a corresponding one of the first and second pairs of wheel brakes 172. It is contemplated that a plurality of pump pistons 189 could be associated with each of the first and second pump outputs 186 and 188, in some configurations of the brake system 170.

The secondary brake module of the brake system 170 may function as a source of pressure to provide a desired pressure level to selected ones of the wheel brakes 172 in a backup or “failed” situation, when, for some reason, the master cylinder 178 is unable to provide fluid to those selected wheel brakes 172. Accordingly, the secondary brake module may be directly fluidly connected to the reservoir 176, for exchanging hydraulic fluid between these components without having to route the fluid through a (potentially failed) motor-driven master cylinder 178 or another structure of the brake system 170.

The secondary brake module can be used to selectively provide hydraulic fluid to at least one of the wheel brakes 172 in a backup braking mode, but also in an enhanced braking mode, which can occur on its own and/or concurrently with either the backup braking mode or a non-failure normal braking mode. Examples of suitable enhanced braking mode functions available to the brake system 170 may include, but not be limited to, “overboost” (in which higher pressure is provided to a particular brake than would normally be available from the master cylinder 178 alone) and “volume-add” (in which more fluid is provided to a particular brake than would normally be available from the master cylinder 178). These enhanced braking modes may be facilitated, in some use environments, by the pump piston(s) 190. For example, in at least one of the normal non-failure braking mode and the backup braking mode, the secondary brake module can then supply boosted-pressure (above what was obtained from the master cylinder 178) hydraulic fluid to at least one of the first and second pump outputs 186 and 188.

The brake system 170 shown in FIG. 6 also includes at least one electronic control unit (“ECU”) 190, for controlling at least one of the master cylinder 178 and the secondary brake module (via electric pump motor 192) responsive to at least one brake pressure signal, with first and second ECUs 190A, 190B being shown and described herein. The ECUs 190A, 190B may include microprocessors and other electrical circuitry. The ECUs 190A, 190B receive various signals, process signals, and control the operation of various electrical components of a corresponding brake system 170 in response to the received signals, in a wired and/or wireless manner. The ECUs 190A, 190B can be connected to various sensors such as the reservoir fluid level sensor(s) 178, pressure sensors, travel sensors, switches, wheel speed sensors, and steering angle sensors. The ECUs 190A, 190B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 190A, 190B may be connected to the instrument cluster for collecting and supplying information related to warning indicators such as an ABS warning light, a brake fluid level warning light, and a traction control/vehicle stability control indicator light. It is contemplated that at least one of the ECUs 190A and 190B may be, for example, integrated with the master cylinder 178 or the electric pump motor 192.

The first and second ECUs 190A and 190B may divide the control tasks for the brake system 100 in any desired manner, and may be readily configured by one of ordinary skill in the art for a particular use environment of a brake system, though it is contemplated that any control tasks performed by one or more ECUs 190 will be accomplished responsive to at least one brake pressure signal and/or a braking signal produced by the deceleration signal transmitter 174. For example, the first ECU 190A may be operative to control the electric motor 180 of the master cylinder 178. The second ECU 190B may be operative to control the electric pump motor 192, and potentially, as will now be discussed, at least one of the iso/dump control valve arrangements and at least one of the first and second traction control iso valves.

An iso/dump control valve arrangement is shown in FIG. 6 as being associated with each wheel brake 172 of the plurality of wheel brakes 172. Each iso/dump control valve arrangement includes an iso valve 191 and a dump valve 194, for providing desired fluid routing to an associated wheel brake 172. The reservoir 176 is hydraulically connected to the master cylinder 178 and to each of the iso/dump control valve arrangements, such as via the return line 196. The iso/dump control valve arrangements each include respective serially arranged iso and dump valves 191 and 194. The normally open iso valve 191 for each iso/dump control valve arrangement is located hydraulically between a respective wheel brake 172 and the master cylinder 178 and the normally closed dump valve 194 for each iso/dump control valve arrangement is located hydraulically between a respective wheel brake 172 and the reservoir 176, for the corresponding wheel brake 172.

The iso/dump control valve arrangements may selectively provide slip control to at least one wheel brake 172 powered by the master cylinder 178 and/or the secondary brake module previously mentioned. More broadly, the iso/dump control valve arrangement, and/or other valves of the brake system 170, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

A first traction control iso valve 198 is hydraulically interposed between the master cylinder 178 and at least one iso/dump control valve arrangement via the first MC output 182. A second traction control iso valve 200 is hydraulically interposed between the master cylinder 178 and at least one iso/dump control valve arrangement via the second MC output 184. As shown in FIG. 6, it is contemplated that an iso/dump control valve arrangement may be associated with each wheel brake 172 of the first and second pairs of wheel brakes. The first traction control iso valve 198 is hydraulically interposed between the motor-driven master cylinder 178 and the iso/dump control valve arrangements of the first pair of wheel brakes 172. Similarly, the second traction control iso valve 200 is hydraulically interposed between the motor-driven master cylinder 178 and the iso/dump control valve arrangements of the second pair of wheel brakes 172.

As can be seen, each iso/dump control valve arrangement in the brake system 170 of FIG. 6 is in direct or indirect fluid communication with both a selected one of the first and second MC outputs 182 and 184 and a selected one of the first and second pump outputs 186 and 188 for selectively receiving pressurized fluid therefrom, such as during different braking modes or otherwise as desired. One of ordinary skill in the art will be readily able to configure a brake system 170 for any particular use application as desired.

A brake pressure signal is at least one input that an ECU 190 may consider and responsively control one or more other components of the brake system 170, to achieve desired braking results for a particular use environment. One potential source of the brake pressure signal is a brake pressure sensor. For example, and as shown in the Figures, the brake system 170 can include at least one, such as at least two, brake pressure sensors 202. As can be seen in FIG. 6, a first brake pressure sensor 202A may be interposed hydraulically between a selected iso/dump control valve arrangement and a corresponding rear brake of a chosen one of the first and second pairs of wheel brakes 172, and a second brake pressure sensor 202B may be interposed hydraulically between an other iso/dump control valve arrangement and a corresponding rear brake of an other one of the first and second pairs of wheel brakes 172. Either along with or instead of the first and second brake pressure sensors 202A, 202B, a third brake pressure sensor 202C may be interposed hydraulically between the first traction control iso valve 198 and the master cylinder 178, and/or a fourth brake pressure sensor 202D may be interposed hydraulically between the second traction control iso valve 200 and the master cylinder 178. One of ordinary skill in the art can readily provide a desired number/position/type of pressure sensors 138 for a particular brake system 100.

In the brake system 100 of FIG. 1, a single return line 196 places the reservoir 176 and each pump piston 189 in hydraulic connection. The brake system 170 also includes a pump inlet attenuator 204 interposed hydraulically between the reservoir 176 and the pump pistons 189 for “smoothing” fluid flow therebetween. The pump inlet attenuator 204 is in direct fluid connection with the reservoir 176 via the single return line 196 and regulates pressure in the single return line 196 to reduce pressure fluctuations at an inlet side of each pump piston 189 via solely mechanical pressure attenuation. At least a portion of the pump inlet attenuator 204 may be in fluid communication with an ambient space outside the brake system 170 as desired. The pump inlet attenuator 204 may be a single pump inlet attenuator 204 as shown and discussed herein, or it is contemplated that multiple pump inlet attenuators (not shown) may be provided for certain use environments of the brake system 170.

Known brake systems require the column of fluid in the return line 196 to accelerate and decelerate due to the flow ripple generated at the inlets of the pump pistons 189. This causes undesirable pressure ripple and decreased pump volumetric efficiency. Conversely, presence of the pump inlet attenuator 204 facilitates improved pump build rate performance with a smaller-diameter and/or longer return line 196. The pump inlet attenuator 204 (A.K.A., “pump inlet damper”) can be packaged inline in the return line 196 (e.g., in a reservoir hose adapter of the brake system 170) or “piggybacked” in a housing body structure of another component (e.g., a secondary brake module). Since the pump pistons 189 of the brake system 170 pull relatively low-pressure fluid from the return line 196 (within which the pump inlet attenuator 204 is inline), the pump inlet attenuator 204 does not need to be able to withstand the relatively high pressures developed in conduits sourced from the master cylinder 178. Thus, the pump inlet attenuator 204 can service both/all of the pump pistons 189 concurrently, but still with relatively inexpensive (e.g., molded plastic) components since the pump inlet attenuator 204 is operating in a low-pressure environment, as shown.

Conversely, and as previously mentioned, the accumulator assembly 100 shown in FIGS. 1-5 can be used in at least a medium-pressure environment. To that end, a first accumulator assembly 100A is interposed hydraulically between at least one wheel brake 172 of the first pair of wheel brakes 172 and at least one of the first MC output 182 and the first pump output 186. A second accumulator assembly 100B is interposed hydraulically between at least one wheel brake 172 of the second pair of wheel brakes 172 and at least one of the second MC output 184 and the second pump output 188. As shown in the brake system 170 depicted in FIG. 6, as an example, a chosen one of the first and second accumulator assemblies 100A and 100B may be interposed hydraulically between a corresponding wheel brake 172 of the plurality of wheel brakes 172 and at least one associated iso/dump control valve arrangement. More specifically, the first accumulator assembly 100A may be interposed fluidically between the first traction control iso valve 198 and at least a chosen wheel brake 172 of the first pair of wheel brakes 172, and the second accumulator assembly 100B may be interposed fluidically between the second traction control iso valve 200 and at least a chosen wheel brake 172 of the second pair of wheel brakes 172.

As shown in FIG. 6 by way of example, the first and second accumulator assemblies 100A and 100B each may be in fluid communication with, and configured to provide pressurized hydraulic fluid to, a corresponding front wheel brake 172 more quickly than a known source of pressurized hydraulic fluid (either the motor-driven master cylinder 178 or the secondary brake module) would be able to get pressurized hydraulic fluid to the corresponding front wheel brake(s) 172, given the brake system 170 configuration. (That is, each accumulator assembly 100A, 100B selectively stores fluid in the MPA cavity 110 for supply to the corresponding front brake 172.) This may be helpful, for example, to facilitate an expedited pressure boost to a corresponding at least one wheel brake during a “spike apply” situation or other quick-response command by a user (e.g., “slamming on” the brakes when a fast stop of a vehicle is desired), particularly when there is a running clearance between a brake pad and rotor that is desired to be taken up quickly.

As is known by one of ordinary skill in the art, electric motors such as the electric motor 180 of the master cylinder 178 or the electric pump motor 192 have “inertia” and make take some, albeit minor, amount of time to respond to a brake actuation command. Similarly, delay in a brake actuation situation may arise from the time needed for hydraulic fluid to transmit pressure the distance from a known source of hydraulic fluid, and/or even a minor amount of “drag” within hydraulic passages in a housing 108. As a result, the first and second accumulator assemblies 100A, 100B may help improve speed from command to action in certain use environments for a brake system 172.

With reference again to FIG. 6, the reservoir 176 and motor-driven master cylinder 178 may be co-located in a first housing (indicated schematically by dashed line “1” in those Figures), and the secondary brake module may be located in a second housing (indicated schematically by dashed line “2” in those Figures), spaced apart from the first housing. Optionally, and also as shown in FIG. 6, the iso/dump control valve arrangements, the first and second accumulator assemblies 100A and 100B, and/or the first and second traction control iso valves 198 and 200 may also be located in the second housing.

The first and second housings (and included/co-located components) of any brake systems 170 may be provided and configured for a particular use application by one of ordinary skill in the art based upon factors including, but not limited to, achieving desired outcomes in at least one of design, manufacturing, service, spatial utilization in the vehicle, cost, size, regulatory compliance, or the like.

It is contemplated that various other components, such as electric service and/or parking brake motors, could be provided by one of ordinary skill in the art to achieve desired configurations for particular use environments, in the brake system 170 described herein. For example, while a number of filters and pressure or other sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

It is contemplated that, while the various components are shown schematically in certain arrangements in the Figures, the components might not reach the precise relative configurations shown, depending on operating conditions in a particular use environment. For example, a poppet might not shuttle to entirely occlude an associated valve seat. However, one of ordinary skill in the art will understand which potential other positions may substantially produce a desired outcome, for a particular use environment.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. An accumulator assembly, comprising:
a medium pressure accumulator, including
an MPA cavity including at least one brake-side passage adjacent a first end thereof,
an MPA piston for reciprocal longitudinal motion within the MPA cavity responsive to a predetermined amount of hydraulic fluid flow through the brake-side passage, and
an MPA biasing spring for urging the MPA piston toward the first end of the MPA cavity; and
a powered MPA two-way valve interposed fluidically between the brake-side passage of the MPA cavity and at least one corresponding wheel brake, the MPA two-way valve including
an MPA two-way valve cavity placing the brake-side passage of the MPA cavity and the at least one corresponding wheel brake in selective fluid communication via both of an MPA two-way valve fill fluid path configured to provide pressurized hydraulic fluid to the MPA cavity and an MPA two-way valve supply fluid path configured to remove pressurized hydraulic fluid from the MPA cavity,
an MPA two-way brake-fill valve seat located along the MPA two-way valve supply fluid path and at least partially defined by an interior wall of the MPA two-way valve cavity,
an MPA two-way valve poppet carried within the MPA two-way valve cavity, the MPA two-way valve poppet including a poppet throughbore extending longitudinally therethrough from a first poppet end, adjacent the MPA two-way brake-fill valve seat, to a second poppet end separated longitudinally from the first poppet end, the second poppet end defining an MPA two-way MPA-fill valve seat located along the MPA two-way valve fill fluid path, and the poppet throughbore selectively routing fluid flow therethrough along the MPA two-way valve fill fluid path, and
an MPA two-way valve MPA-fill occluder, located along the MPA two-way valve fill fluid path and configured to selectively contact the MPA two-way MPA-fill valve seat;
wherein the MPA two-way valve poppet is configured for reciprocal motion between a poppet open position and a poppet closed position, reciprocal motion of the MPA two-way valve poppet occurring at least partially responsive to a predetermined amount of fluid pressure differential between the MPA cavity and the at least one corresponding wheel brake;
wherein an MPA two-way valve poppet shoulder contacts the MPA two-way brake-fill valve seat to occlude fluid flow therepast along the MPA two-way valve supply fluid path responsive to the MPA two-way valve poppet achieving the poppet closed position; and
wherein the MPA two-way valve MPA-fill occluder contacts the MPA two-way MPA-fill valve seat to occlude fluid flow therepast along the MPA two-way valve fill fluid path responsive to the MPA two-way valve poppet achieving the poppet open position.

2. The accumulator assembly of claim 1, wherein the MPA two-way valve includes an armature for selective longitudinally reciprocating motion with respect to the MPA two-way valve cavity between first and second armature positions, wherein the MPA two-way valve poppet is held into engagement with the MPA two-way brake-fill valve seat, in the poppet closed position, responsive to the armature being in the first armature position, and wherein the MPA two-way valve poppet is permitted to selectively reciprocate between the poppet closed position and the poppet open position responsive to the armature being in the second armature position.

3. The accumulator assembly of claim 2, including a core for selectively magnetically attracting the armature, the core being located longitudinally directly adjacent a core-activated surface of the armature, the armature being longitudinally interposed between the core and the MPA two-way valve poppet, the core being selectively energized to magnetically drive the armature between the first and second armature positions.

4. The accumulator assembly of claim 2, including a poppet spring biasing the MPA two-way valve poppet toward the poppet closed position and sealing engagement with the MPA two-way MPA-fill valve seat when the armature is in the second armature position.

5. The accumulator assembly of claim 2, including a core spring biasing the armature toward the first armature position.

6. The accumulator assembly of claim 2, wherein the MPA two-way valve MPA-fill occluder comprises an occluder ball carried by the armature for selective engagement with the MPA two-way MPA-fill valve seat.

7. The accumulator assembly of claim 3, wherein a core sleeve is received at least partially in a housing also at least partially defining the MPA cavity, the core sleeve being configured to maintain the core in spaced relationship with the armature, the armature being at least partially enclosed within the core sleeve and guided thereby for selective longitudinal reciprocating motion with respect to the core responsive to energization of the core.

8. The accumulator assembly of claim 7, wherein the core sleeve completely encloses the MPA two-way valve poppet, with a reduced-diameter sleeve shoulder, located on an opposite end of the MPA two-way valve poppet from the core, at least partially defining the MPA two-way valve seat by comprising at least a portion of an interior wall of the MPA two-way valve cavity.

9. The accumulator assembly of claim 7, wherein a poppet sleeve is carried by the armature, enclosed within the core sleeve, and collectively encloses the MPA two-way fill valve seat and at least a portion of the poppet, the poppet sleeve laterally interposed between at least a portion of the MPA two-way valve supply fluid path and at least a portion of the MPA two-way valve fill fluid path.

10. The accumulator assembly of claim 1, wherein reciprocal motion of the MPA two-way valve poppet occurs at least partially responsive to a fluid pressure differential between the MPA cavity and the at least one corresponding wheel brake.

11. The accumulator assembly of claim 10, wherein reciprocal motion of the MPA two-way valve poppet between the poppet open position and the poppet closed position is operative to facilitate fluid flow between the MPA cavity and at least one corresponding wheel brake alternately along the MPA two-way valve supply fluid path and along the MPA two-way valve fill fluid path, respectively.

12. The accumulator assembly of claim 1, wherein the brake-side passage of the MPA cavity includes a circumferential groove at least partially containing a resilient annular seal surrounding at least an MPA-side portion of the MPA two-way valve, the annular seal preventing passage of hydraulic fluid between the MPA cavity and the at least one corresponding wheel brake apart from at least one of the MPA two-way valve supply fluid path and the MPA two-way valve fill fluid path.

13. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary brake module configured for selectively providing pressurized hydraulic fluid at first and second pump outputs for actuating the first and second pairs of wheel brakes in at least one of a normal non-failure braking mode and a backup braking mode, the secondary brake module including an electric pump motor configured to selectively pressurize the hydraulic fluid by transmitting rotary motion to at least two pump pistons, each pump piston providing pressurized hydraulic fluid to a corresponding one of the first and second pump outputs, each of the first and second pump outputs providing fluid to a corresponding one of the first and second pairs of wheel brakes;
first and second accumulator assemblies, with each accumulator assembly being interposed hydraulically between at least one wheel brake of a corresponding first or second pair of wheel brakes and at least one of the corresponding first or second MC output and the corresponding first or second pump output, each of the first and second accumulator assemblies including a medium pressure accumulator and a powered MPA two-way valve interposed fluidically between a brake-side passage of the medium pressure accumulator and the corresponding at least one wheel brake; and
an electronic control unit for controlling at least one of the secondary brake module and the master cylinder responsive to at least one brake pressure signal;
wherein the first and second accumulator assemblies each facilitate an expedited pressure boost to the corresponding at least one wheel brake for a spike-apply situation of the brake system.

14. The brake system of claim 13, including a pump inlet attenuator interposed hydraulically between the reservoir and the pump pistons and in direct fluid connection with the reservoir via a single return line;

15. The brake system of claim 13, including an iso/dump control valve arrangement associated with each wheel brake of the plurality of wheel brakes, each iso/dump control valve arrangement being controlled by the electronic control unit, and a chosen one of the first and second accumulator assemblies being interposed hydraulically between a corresponding wheel brake of the plurality of wheel brakes and at least one associated iso/dump control valve arrangement.

16. The brake system of claim 13, wherein each accumulator assembly is in fluid communication with a front brake of a respective pair of wheel brakes for selectively storing fluid in the MPA cavity for supply to the corresponding front brake.

17. The brake system of claim 13, including a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet.

18. The brake system of claim 17, wherein the first accumulator assembly is interposed fluidically between the first traction control iso valve and at least a chosen wheel brake of the first pair of wheel brakes, and the second accumulator assembly is interposed fluidically between the second traction control iso valve and at least a chosen wheel brake of the second pair of wheel brakes.

19. The brake system of claim 15, wherein a first brake pressure sensor is interposed hydraulically between a selected iso/dump control valve arrangement and a corresponding rear brake of a chosen one of the first and second pairs of wheel brakes, and a second brake pressure sensor is interposed hydraulically between an other iso/dump control valve arrangement and a corresponding rear brake of an other one of the first and second pairs of wheel brakes.

20. The brake system of claim 13, wherein the electronic control unit is a first electronic control unit controlling the motor-driven master cylinder, and the brake system includes a second electronic control unit controlling the secondary brake module, wherein both the first and second electronic control units control the respective motor-driven master cylinder and secondary brake module responsive to at least one brake pressure signal.
